(19) United States
(12) Patent Application Publication
(10) Pub. No.: US 2014/0302233 A1
(43) Pub. Date: Oct. 9, 2014

(54) MOLDING ROLLER AND METHOD OF MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/067,947

(22) Filed: Oct. 31, 2013

(30) Foreign Application Priority Data
Apr. 3, 2013 (TW) 102112077

(51) Int. Cl. B05D 1/02

(52) U.S. Cl. CPC B05D 1/02
USPC 427/135; 425/385

(57) ABSTRACT

A molding roller includes a roller body and a molding film. The roller body includes a substantially cylindrical surface. The molding film is coated onto the cylindrical surface and includes a molding surface facing away from the cylindrical surface. A micro-structure pattern is formed on the molding surface. The molding film is made of a polymer material including a PDMS and a number of SiO₂ nano-particles permeating in a network structure of the PDMS.

### BACKGROUND

1. Technical Field

The present disclosure relates to molding devices, and particularly to a molding roller and a method of manufacturing the molding roller.

2. Description of Related Art

Molding rollers generally include a roller body and a copper layer coated on an outer cylindrical surface of the roller body. A micro-structure pattern is formed on the copper layer for molding an optical element, such as a brightness enhancement film. However, when a part of the micro-structure pattern of the copper layer is damaged, the entire copper needs to be replaced, which increases a cost of the molding roller.

Therefore, it is desirable to provide a molding roller and a method of manufacturing the molding roller to overcome the limitations described.

### BRIEF DESCRIPTION OF THE DRAWINGS

FIG. 1 is an isometric view of a molding roller in accordance with an exemplary embodiment.

FIG. 2 is a pictural flowchart of a method of manufacturing the molding roller of FIG. 1.

### DETAILED DESCRIPTION

Embodiments of the disclosure will be described with reference to the drawings.

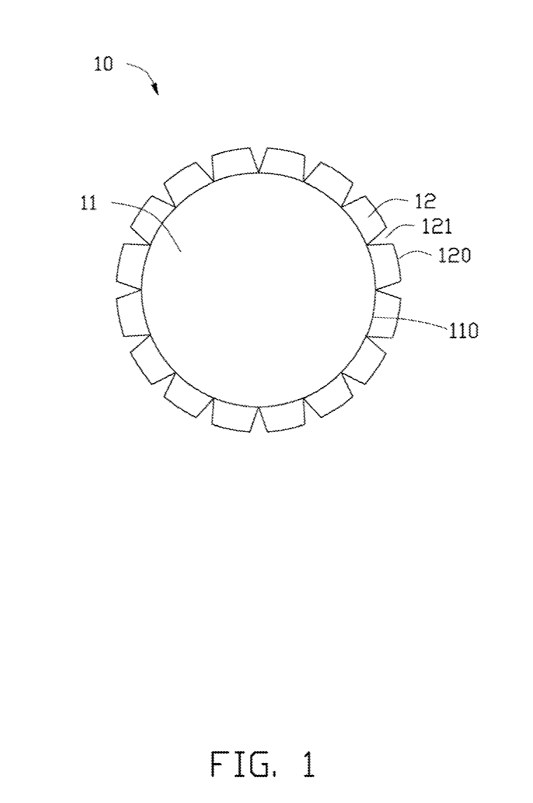

FIG. 1 shows a molding roller 10, which is used to mold an optical element (not shown), such as a brightness enhancement film. The molding roller 10 includes a roller body 11 and a molding film 12.

The roller body 11 is substantially cylindrical and includes a cylindrical surface 110. The roller body 11 is made of metal, such as copper, and a Mohs hardness of the roller body 11 is greater than about 2.5. In the embodiment, in order to improve an adhesive force of the cylindrical surface 110, the cylindrical surface 110 is roughened by a roughing process.

The molding film 12 is spray-coated onto the cylindrical surface 110 and forms an annular tube sleeved on the roller body 11. The molding film 12 includes a molding surface 120 facing away from the cylindrical surface 110. A micro-structure pattern 121 is formed on the molding surface 120 to mold the optical element. The molding film 12 is made of flexible polymer material including polydimethylsiloxane (PDMS) and a number of silicon dioxide (SiO₂) nano-particles permeated in a network structure of the PDMS. The chemical formula of PDMS is CH₃[Si(CH₃)₂O]ₙSi(CH₃)₃, where “n” is the number of repeating [Si(CH₃)₂O] monomer units. The PDMS has a good bonding resistance with a resin of the optical element, which makes the molding film 12 easily separate from the optical element. The SiO₂ nano-particles improve a strength and an abrasion resistance of the molding film 12. The SiO₂ nano-particles grow in the network structure of the PDMS via a sol-gel method. A diameter of the SiO₂ nano-particles is from about 1 nm to about 100 nm.

In the embodiment, a thickness of the molding film 12 is substantially uniform. The molding film 12 is formed on the entire cylindrical surface 110. A length of the molding film 12 is substantially equal to a length of the roller body 11. The micro-structure pattern 121 includes a number of recesses defined in the molding surface 120.

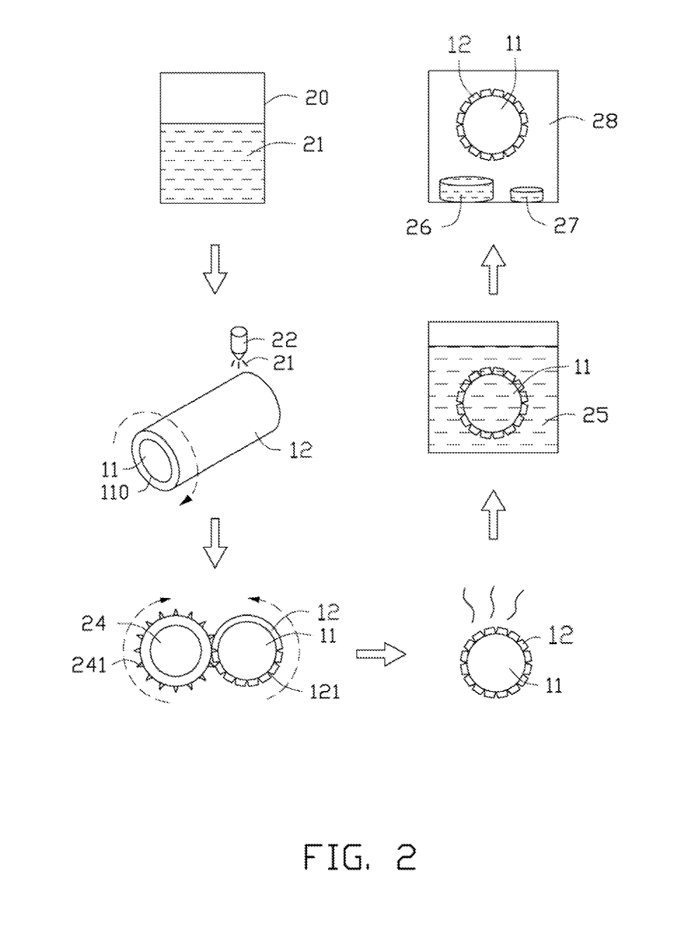

FIG. 2 shows a method of manufacturing the molding roller 10, according to an exemplary embodiment. The method includes steps S101-S106.

S101: a PDMS solution 21 is provided. The PDMS solution 21 is made by mixing the PDMS with a curing agent in a proportion of about 10:1 to about 15:1. The PDMS and the curing agent are mixed uniformly in a receiver 20, and the PDMS is hardened by the curing agent to form the network structure. If bubbles are formed during the process of mixing, the PDMS solution 21 must be deaerated by a vacuum deaeration process. The curing agent is an ethylenediamine.

S102: the PDMS solution 21 is sprayed onto the cylindrical surface 110 of the roller body 11 by a spraying device 22 to form the molding film 12. As the roller body 11 rotates, the PDMS solution 21 is sprayed on the entire cylindrical surface 110, thereby forming the molding film 12 on the roller body 11. The thickness of the molding film 12 is substantially uniform, and the thickness can be controlled by adjusting a rotation speed of the roller body 11 and by adjusting a spraying quantity of the spraying device 22.

In order to improve adhesiveness between the roller body 11 and the molding film 12, the cylindrical surface 110 is roughened by sandblasting before the molding film 12 is formed on the roller body 11.

S103: a metal roller 24 having a transfer printing pattern 241 is provided. The metal roller 24 is rolled once over the roller body 11 to form a micro-structure pattern 121 on the molding film 12. A pressure of the metal roller 40 applied on the molding film 12 is constant.

S104: the micro-structure pattern 121 of the molding roller 10 is solidified by placing the molding roller 10 in an oven having a temperature of about 25 degrees Celsius (° C.) to about 100° C.. In the embodiment, the temperature of the oven is about 65.

S105: the solidified molding roller 10 is submerged in an additive 25 for a preset time duration, such as ten minutes. The molding roller 10 swells up from absorbing the additive 25, and the additive 25 permeates the network structure of the molding film 12. The additive 25 is a siloxane liquid and includes tetraethoxysilane (TEOS).

S106: the swelled molding roller 10 is placed in a container 28 containing a container of deionized water 26 and a container of a weak alkaline catalyst 27. The deionized water 26 and the weak alkaline catalyst 27 are vaporized when the temperature of the container 28 is increased. The vaporized deionized water 26 and the vaporized weak alkaline catalyst 27 permeate into the network structure of the molding film 12. The additive 25 is hydrolyzed and condensed by the vaporized deionized water 26 and the vaporized weak alkaline catalyst 27. A reactant is a number of SiO₂ nano-particles permeated in the network structure of the PDMS.

In the embodiment, the deionized water 26 and the weak alkaline catalyst 27 increase a reaction speed of the reaction between the additive 25 and the number of SiO₂ nano-particles. In other embodiments, the deionized water 26 and the weak alkaline catalyst 27 can be omitted to reduce a cost of manufacturing. A Young's modulus of the molding film 12 can be adjusted by adjusting a reaction time of the additive 25. The weak alkaline catalyst 27 is a 95% 2-amino-2-methyl-propanol solution (AMP-95). A volume ratio between the weak alkaline catalyst 27 and the deionized water 26 is about 1:5.

In the embodiment, the residual additive 25 adhered on the molding film 12 is cleaned off by a nitrogen gun (not shown).

In the embodiment, since the micro-structure pattern 121 is transferred onto the molding film 12 sprayed onto the roller body 11, a manufacturing process of the molding roller 10 is simplified.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
an roller body comprising a cylindrical surface; and
a molding film coated on the cylindrical surface, and comprising a molding surface facing away from the cylindrical surface and a micro-structure pattern formed on the molding surface;
wherein the molding film is made of a polymer material comprising a polydimethylsiloxane (PDMS) and a plurality of silicon dioxide (Si0₂) nano-particles permeating in a network structure of the PDMS.

2. The molding roller of claim 1, wherein a thickness of the molding film is uniform.

3. The molding roller of claim 1, wherein the molding film is formed on the entire cylindrical surface, and a length of the molding film is substantially equal to a length of the roller body.

4. A method of manufacturing a molding roller, comprising:
providing a polydimethylsiloxane (PDMS) solution;
spraying the PDMS solution onto a cylindrical surface of a roller body to form a molding film;
providing a metal roller having a transfer printing surface, the transfer printing surface comprising a transfer printing pattern;
transferring the transfer printing pattern of the metal roller on the molding film to form a micro-structure pattern;
solidifying the micro-structure pattern; and
submerging the solidified molding roller in an additive which is a siloxane liquid, with a plurality of silicon dioxide (SiO₂) nano-particles grew in the molding film.

5. The method of claim 4, wherein the PDMS solution is made by mixing the PDMS with a curing agent in a proportion of about 10:1 to about 15:1.

6. The method of claim 4, wherein the cylindrical surface is roughened by sandblasting before the molding film is formed on the roller body.

7. The method of claim 4, wherein the additive comprises a tetraelthoxy silane (TEOS).

8. The method of claim 4, wherein the molding roller is swelled under the additive, the swelled molding roller is positioned in a container receiving a deionized water and a weak alkaline catalyst.

9. The method of claim 8, wherein the additive is hydrolyzed and condensed under affecting of the deionized water and the weak alkaline catalyst.

10. The method of claim 9, wherein a volume ratio of the weak alkaline catalyst to the deionized water is about 1:5, the weak alkaline catalyst is a 95% 2-amino-2-methyl-propanol solution.
